(19) United States
(12) Patent Application Publication
(10) Pub. No.: US 2015/0120252 A1
(43) Pub. Date: Apr. 30, 2015

(54) CAX MODEL SYNCHRONIZATION

(71) Applicant: Brigham Young University, Provo, UT (US)

(72) Inventors: Ammon Hepworth, Provo, UT (US); Mark S. Trent, Provo, UT (US); Charles Greg Jensen, Provo, UT (US); Kevin Tew, Provo, UT (US); Daniel Ricks, Provo, UT (US); Walter Edward Red, Provo, UT (US)

(21) Appl. No.: 14/529,001

(22) Filed: Oct. 30, 2014

Related U.S. Application Data
(60) Provisional application No. 61/897,536, filed on Oct. 30, 2013.

(51) Int. Cl. G06F 17/50; H04L 29/06

(52) U.S. Cl. CPC G06F 17/50; H04L 65/403
USPC 703/1

(57) ABSTRACT

A computer-implemented method for collaborative editing of an electronic model of a design object may include (1) identifying clients configured to submit design operations to be performed on a shared design model, (2) receiving, from a first client, a first design operation to be performed on the shared design model prior to receiving, from a second client, a second design operation to be performed on the shared design model, (3) performing the first design operation prior to attempting to perform the second design operation, (4) identifying a conflict between the two design operations, and (5) in response to identifying the conflict between the design operations, notifying the second client that the second design operation was not performed on the shared design model. Various other methods and systems are also disclosed herein.

### CROSS-REFERENCE TO RELATED APPLICATIONS

This application claims the benefit of U.S. provisional application 61/897,536 entitled “Model Consistency and Conflict Resolution with Data Preservation in Multi-user CAD” and filed on 30 Oct. 2013. The foregoing application is incorporated herein by reference.

### BACKGROUND

1. Technical Field

The subject matter disclosed herein relates generally to systems and methods for collaborative editing of an electronic model of a design object.

2. Discussion of the Background

Computer-aided systems such as computer-aided design, engineering, analysis, and manufacture (collectively, CAx) historically have enabled individual designers to work on an electronic model of a design object, or a portion thereof. Most design projects, however, require collaboration between several designers. The primary challenge in developing a CAx system that can accommodate multiple users is preventing conflicts and design inconsistencies as multiple users work on a single shared model.

To accommodate the needs of multiple users, CAx systems have typically taken two approaches: centralized and replicated. Centralized collaborative CAx systems utilize a central server to perform modeling operations. Client workstations provide a view into the model stored in a centralized database and tools for performing design operations on the model. The central server arbitrates which user is permitted to work on which part of the model at any given time. Centralized collaborative CAx systems typically require considerable network bandwidth to update client views of the shared model.

Replicated collaborative CAx systems store copies of the design model on each of the clients. As with centralized systems, locking mechanisms are used to assure that only one user modifies any one part of the model at a time. However with a replicated system, there is no central server to arbitrate editing locks. In some cases, conflicts develop between the different copies of the design model, requiring manual resolution of the conflicts and the potential loss of previous design operations.

Given the foregoing, what is needed is additional and improved systems and methods for collaborative editing of an electronic model of a design object, in particular, systems and methods that facilitate multiple simultaneous users. The embodiments disclosed herein were developed in response to these issues.

### SUMMARY OF THE INVENTION

As will be described in greater detail below, the subject matter disclosed herein describes various systems and methods for collaborative editing of an electronic model of a design object. In one example, a computer-implemented method for may include (1) identifying clients configured to submit design operations to be performed on a shared design model, (2) receiving, from a first client, a first design operation to be performed on the shared design model prior to receiving, from a second client, a second design operation to be performed on the shared design model, (3) performing the first design operation prior to attempting to perform the second design operation, (4) identifying a conflict between the two design operations, and (5) in response to identifying the conflict between the design operations, notifying the second client that the second design operation was not performed on the shared design model.

In some examples, the computer-implemented method may further include notifying each of the clients that the first design operation was performed on the shared design model. In some examples, notifying each of the clients that the first design operation was performed on the shared design model may include notifying the first client that the first design operation was successfully performed on the shared design model and transmitting the first design operation to the remainder of clients, so that the first design operation can be applied to a copy of the shared design model local to the other clients.

In one embodiment, the computer-implemented method may further include associating a sequence identifier with each design operation performed on the shared design model and notifying each of the clients of the sequence identifier associated with each design operation performed on the shared design model. In some examples, receiving the design operation to be performed on the shared design model may further include receiving from the client submitting the design operation the sequence identifier most recently received by the client.

In one embodiment, the computer-implemented method may further include (1) receiving from the client submitting the design operation a sequence identifier that does not match the sequence identifier associated with the design operation most recently performed on the shared design model, (2) determining, in response to receiving the sequence identifier that does not match the most recent sequence identifier, that at least one design operation performed on the shared design model has not been applied to the client's local copy of the shared design model, and (3) notifying the client submitting the design operation that because at least one design operation performed on the shared design model has not been applied to the client's local copy of the shared design model, the design operation was not performed on the shared design model.

In one example, a computer-implemented method for collaborative editing of an electronic model of a design object may include submitting, from a client, a first design operation to be performed on a shared design model and receiving notification that the first design operation was not performed due to a conflict with a second design operation previously performed on the shared design model. In one embodiment, the computer-implemented method may further include receiving the second design operation previously performed on the shared design model and performing the second design operation on the client's local copy of the shared design model.

In one embodiment, the computer-implemented method may further include resolving, on the client, the conflict between the first design operation and the second design operation and resubmitting, from the client, the first design operation to be performed on the shared design model. In some examples, the computer-implemented method may further include receiving a sequence identifier associated with the second design operation previously performed on the shared design model. In some examples, submitting the first design operation to be performed on the shared design model further may include submitting the sequence identifier associated with the second design operation previously performed on the shared design model.

In one embodiment, the computer-implemented method may further include (1) receiving notification that the first design operation was not performed because the sequence identifier submitted with the first design operation does not match the most recent sequence identifier, (2) receiving one or more previously performed design operations that were performed on the shared design model prior to when the first design operation was submitted, (3) performing the previously performed design operations on the client's local copy of the shared design model, and (4) resubmitting the first design operation with the most recent sequence identifier.

In one embodiment, the computer-implemented method may further include queueing one or more previously performed design operations that were performed on the shared design model in a design operation queue accessible to the client, and retrieving the previously performed design operations from the design operation queue to be performed on the local copy of the shared design model.

In one example, a computer-implemented method for may include (1) performing, on a client, a design operation on the client's local copy of a shared design model, (2) receiving, on the client, one or more previously performed design operations that were performed on the shared design model, (3) identifying a conflict between the design operation and the previously performed design operations, (4) in response to identifying the conflict between the design operation and the previously performed design operations, reversing the design operation and performing the previously performed design operations on the client's local copy of the shared design model, (5) resolving the conflict between the design operation and the previously performed design operations, and (6) submitting the design operation to be performed on the shared design model.

In one example, resolving the conflict between the design operation and one or more previously performed design operations may include (1) receiving the additional previously performed design operations that were performed on the shared design model, (2) performing the additional previously performed design operations on the client's local copy of the shared design model, and (3) determining that performing the previously performed design operation has resolved the conflict between the design operation and the previously performed design operations.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a block diagram depicting model inconsistencies resulting from an unsynchronized order of operations;

FIG. 2 is a block diagram of an environment wherein the system for collaborative editing of an electronic model of a design object may be deployed;

FIG. 3 is a flowchart depicting one embodiment of a method for collaborative editing of a shared electronic model of a design object;

FIG. 4 is a flowchart depicting one embodiment of a method for resolving conflicts arising during collaborative editing of a shared electronic model of a design object;

FIG. 5 is a flowchart depicting one embodiment of a method for data preservation when resolving conflicts arising during collaborative editing of a shared electronic model of a design object;

FIG. 6 is a block diagram depicting a system for collaborative editing of a shared electronic model of a design object;

FIG. 7 is a block diagram depicting a system for collaborative editing of a shared electronic model of a design object;

FIGS. 8A and 8B are block diagrams depicting systems for collaborative editing of a shared electronic model of a design object; and

FIGS. 9A and 9B are block diagrams depicting systems for collaborative editing of a shared electronic model of a design object.

### DETAILED DESCRIPTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, enable the module to achieve the intended purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure is generally directed to systems and methods for collaborative editing of an electronic model of a design object. As will be explained in greater detail below, the systems and methods described herein may facilitate collaboration between multiple designers working on the same design model at the same time, thereby shortening design cycle times.

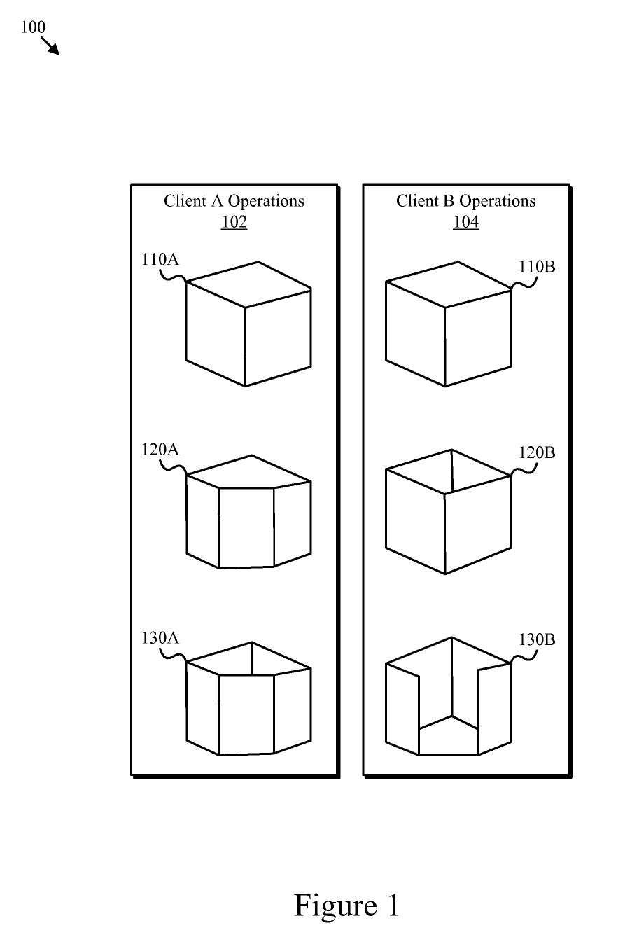

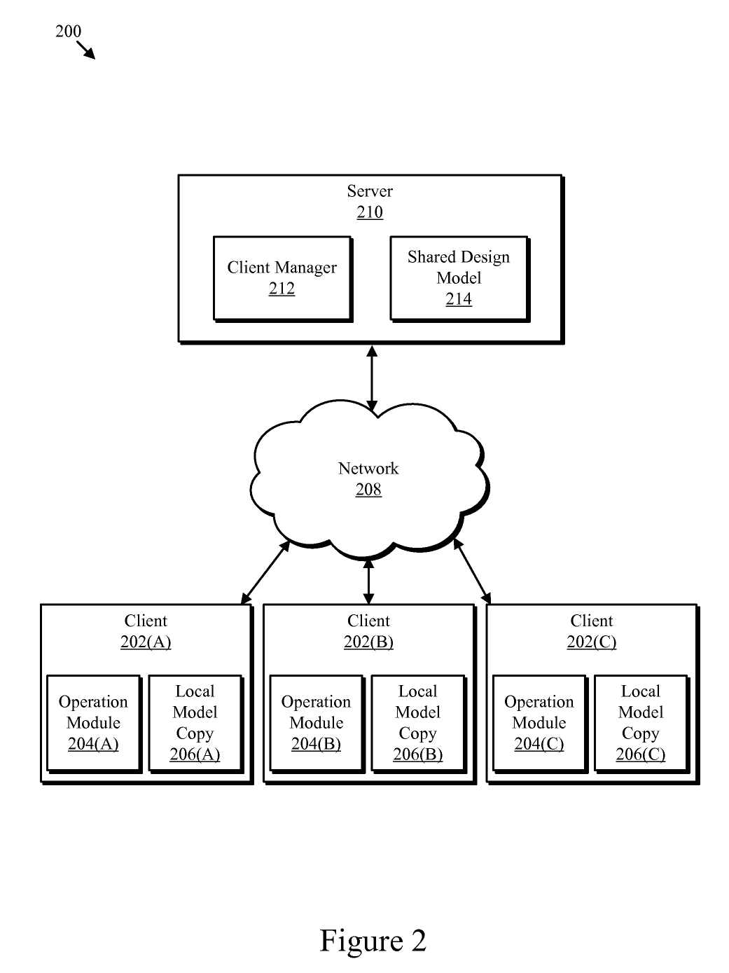

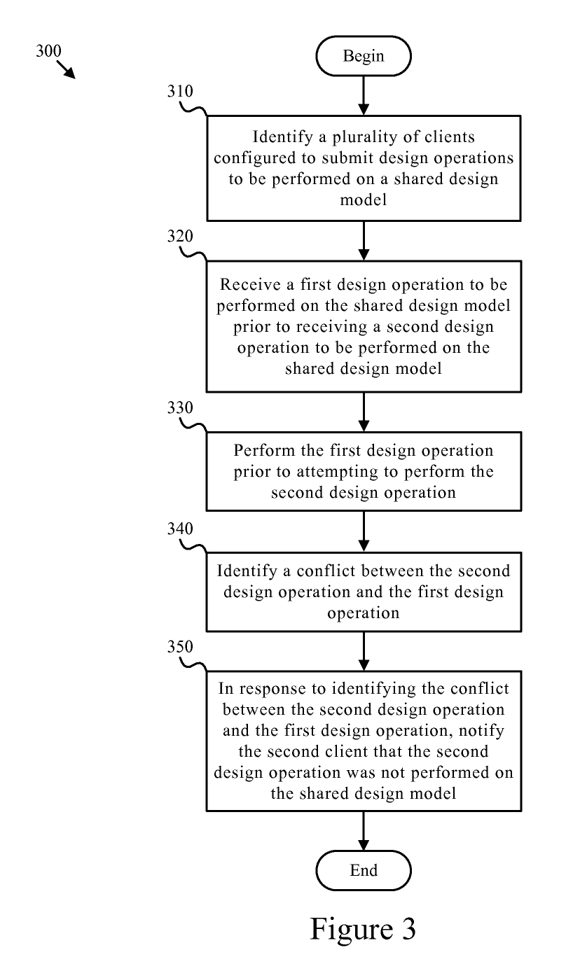

The following will provide, with reference to FIG. 1, an illustration depicting model inconsistencies resulting from an unsynchronized order of operations. FIGS. 2 and 6-9 provide detailed descriptions of exemplary systems for collaborative editing of an electronic model of a design object. Detailed descriptions of corresponding computer-implemented methods will also be provided in connection with FIGS. 3-5.

FIG. 1 illustrates how model inconsistencies can arise as a result of unsynchronized design operations. Object 110A and object 110B represent separate, identical copies of a shared design object on two client workstations, client A and client B. The designer on client A performs a trim operation to obtain object 120A, while the designer on client B performs a shell operation to obtain object 120B. Client A then receives the shell operation performed by client B and applies it to client A's copy of the object to obtain object 130A. Client B receives the trim operation performed by client A and applies it to client B's copy of the object to obtain object 130B. Even though the two designers were operating on distinct parts of the design object, because the operation were not applied in a consistent order, an inconsistency arose between the two copies of the design model. As will be described in greater detail below, the systems and methods described herein may ensure a universally consistent order of operations between copies of a shared design model on multiple workstations. As the work of multiple users is applied to the shared model, design projects may be completed in less time, and without the loss of work that results from design inconsistencies that may arise when design operations are performed in an inconsistent order. By maintaining local copies of the shared design model (or a portion thereof), systems and methods described herein may reduce network bandwidth requirements, since these methods communicate operations applied to the shared model, rather than data-intensive and frequently changing views of the design object.

FIG. 2 is a block diagram depicting one embodiment of an exemplary environment 200 wherein the system for collaborative editing of an electronic model of a design object may be deployed. As illustrated in this figure, environment 200 may include several clients 202, a server 210, and a network 208 that connects clients 202 and server 210. Server 210 may include a client manager 212 and may host a shared design model 214. In another configuration of a deployment environment, server 210 may be an application server hosting client manager 212, with shared design model 214 hosted on a separate application or database server. Each of clients 202 may include an operation module 204 and host a local model copy 206 of all or a portion of shared design model 214. In one embodiment, shared design model 214 may use a different data format that that of local model copy 206 on clients 202. For example, shared design model 214 may be a database containing data that clients may access to create a local model copy on a client that represents all or a portion of the shared design object. In another embodiment, shared design model 214 and local model copy 206 may use the same data format.

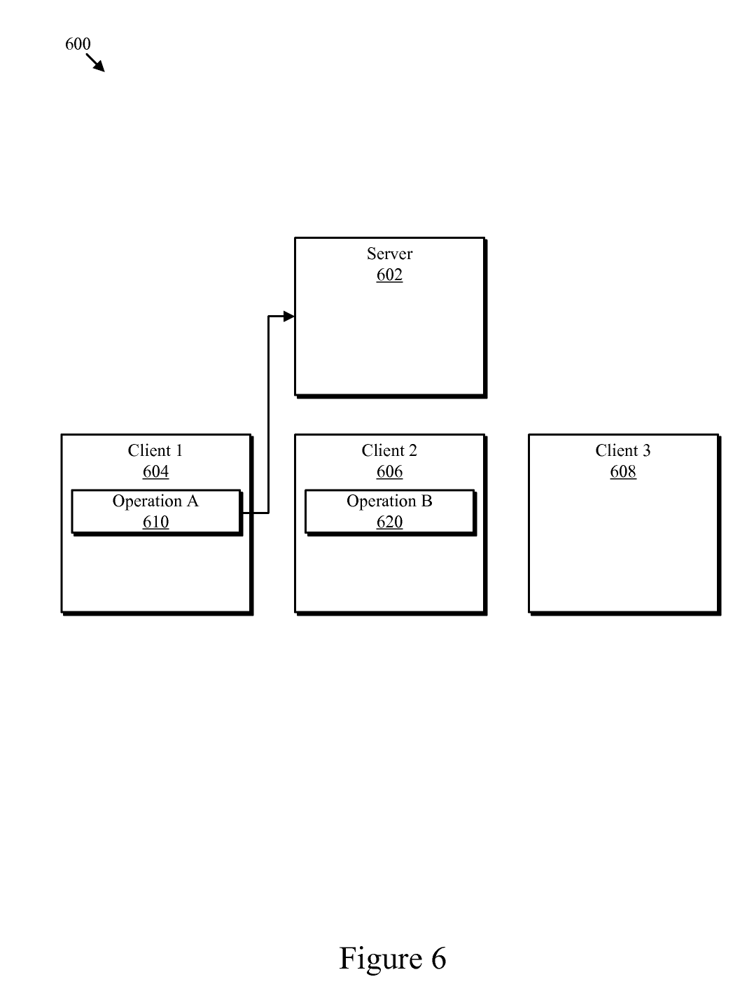

FIG. 3 is a flowchart depicting one embodiment of a method 300 for collaborative editing of an electronic model of a design object. The steps shown in FIG. 3 may be performed by any suitable computer-executable code and/or computing system. In some embodiments, the steps shown in FIG. 3 may be performed by one or more of the components of system 200 in FIG. 2, as well as systems depicted in FIGS. 6-9.

As illustrated in FIG. 3, at step 310 of method 300, one or more of the systems described herein may identify a plurality of clients configured to submit design operations to be performed on a shared design model. For example, client manager 212 may, as part of server 210 in FIG. 2, identify a plurality of clients configured to submit design operations to be performed on shared design model 214.

Client manager 212 may identify clients to submit design operations to be performed on the shared design model in any suitable manner. For example, client manager 212 may provide authentication procedures to determine that the user of the client workstation is authorized to submit operations to be performed on the shared design model. Client manager 212 may also perform a synchronization operation to determine whether the client's local copy of the shared design model is up-to-date and consistent with the centralized copy of the shared design module on the server.

At step 320, one or more of the systems described herein may receive a first design operation to be performed on the shared design model prior to receiving a second design operation to be performed on the shared design model. For example, client manager 212 may, as part of server 210 in FIG. 2, receive, from client 202(A), a first design operation to be performed on shared design model 214 prior to receiving, from client 202(B), a second design operation to be performed on shared design model 214.

At step 330, one or more of the systems described herein may perform the first design operation prior to attempting to perform the second design operation. For example, client manager 212 may, as part of server 210 in FIG. 2, perform the first design operation received from client 202(A) prior to attempting to perform the second design operation received from client 202(B). Systems and methods described herein may implement a “first-to-arrive” approach to performing design operations.

FIG. 6 is a block diagram depicting a system 600 for collaborative editing of a shared electronic model of a design object. As illustrated in FIG. 6, system 600 may include a server 602, client 1 604 that submits operation A 610 to server 602 to be applied to the shared design model, client 2 606 that has performed operation B 620 on its local copy of the shared design model, but has not yet submitted operation B 620 to server 602. System 600 may include one or more other clients, represented by client 3 608. As illustrated in FIG. 6, client 1 610 may submit operation A 610 to server 602 just before client 2 606 submits operation B 620. Because server 602 receives operation A 610 first, server 602 applies operation A 610 to the shared design model before attempting to apply operation B 620.

At step 340, one or more of the systems described herein may identify a conflict between the second design operation and the first design operation. For example, client manager 212 may, as part of server 210 in FIG. 2, may determine that a design operation received from client 202(B) conflicts with a design operation that was previously received from client 202(A) and applied to the shared design model. Returning to FIG. 6, server 602 may determine that performing operation B 620 may create an inconsistency in the shared design model or violate a design constraint because server 602 received operation A 610 and applied it to the shared design model before receiving operation B 620. Client 2 606 was unaware of the inconsistency when submitting operation B 620 because client 2 606 had not yet received operation A 610 from server 602 and applied it to its local copy of the shared design model.

At step 350, one or more of the systems described herein may, in response to identifying the conflict between the second design operation and the first design operation, notify the second client that the second design operation was not performed on the shared design model. For example, client manager 212 may, as part of server 210 in FIG. 2, notify client 202(B) that the second design operation was not performed on shared design model 214, due, for example, to a conflict such as an incompatibility or violation of a design constraint that would result if the second design operation were applied to shared design model 214 after the first design operation was applied.

Notifying a client that a design operation was not performed may be performed in any suitable manner. For example, the server may send an explicit failure notification that the submitted design operation was not completed. The notification may include an error code or description that indicates the reason that the design operation failed. In another example, the client may set a timeout period in which, if the client does not receive notification that the design operation was successfully applied, the client assumes that the operation failed. A combination of explicit notification and a timeout period may be used to advantage, particularly when design operations are transmitted over an unreliable network.

In some examples, method 300 for collaborative editing of an electronic model of a design object may include notifying each client of the plurality of clients that the first design operation was performed on the shared design model. For example, client manager 212 may, as part of server 210 in FIG. 2, notify clients 202(A)-(C) that the first design operation submitted by client 202(A) was successfully applied to shared design model 214.

Client manager 212 may notify clients that the design operation was successfully performed in a variety of ways. In some examples, notifying each of the clients that the first design operation was performed on the shared design model may include notifying the first client that the first design operation was successfully performed on the shared design model. Notifying clients other than the client that submitted the first design operation to the server may include transmitting the first design operation the other clients, so that the first design operation can be applied to each client's local copy of the shared design model.

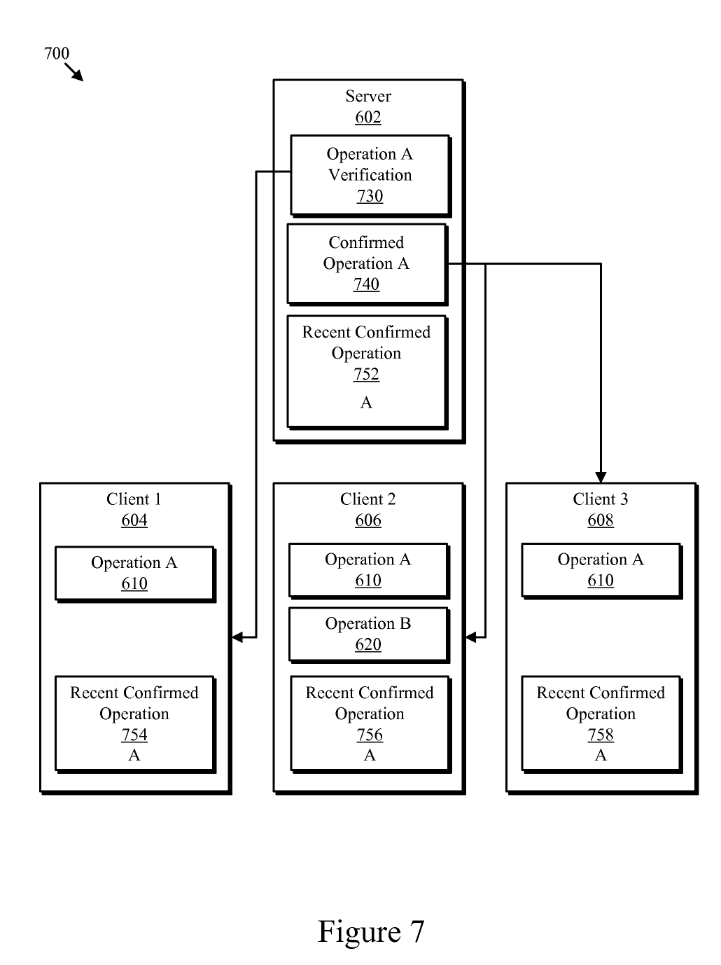

FIG. 7 is a block diagram depicting a system for collaborative editing of a shared electronic model of a design object. FIG. 7 includes the clients and server components shown in FIG. 6, as well as operation A verification (730) and confirmed operation A (740). After client 1 (604) submits operation A (610) to the server 602 and operation A (610) is successfully applied to the shared design model, the server may transmit operation A verification to client 1 to confirm to client 1 that the server received operation A and successfully applied the operation to the shared design object. The server may transmit a copy of operation A as confirmed operation A to other clients in system 700, such as client 2 and client 3. These clients may then apply operation A to their local copies of the shared design model, to maintain consistency with the shared design model on the server (602).

In one embodiment, method 300 for collaborative editing of an electronic model of a design object may include associating a sequence identifier with each design operation performed on the shared design model, and notifying each of the clients of the sequence identifier associated with each design operation performed on the shared design model.

Returning to FIG. 7, system 700 may include recent confirmed operation (752) on the server (602), recent confirmed operation (754) on client 1 (604), recent confirmed operation (756) on client 2 (606), and recent confirmed operation (758) on client 3 (608). After applying operation A (610) to the shared design model, the server may record in recent confirmed operation (752) that operation A was the operation most recently applied to the shared design model. The recent confirmed operation identifier may take a variety of forms, such as a sequential numeric identifier, a universally unique identifier (UUID), a timestamp, etc.

In some examples, receiving the design operation to be performed on the shared design model further includes receiving from the client submitting the design operation the sequence identifier most recently received by the client. As illustrated in FIG. 7, client 2, when submitting operation B to the server, may submit recently confirmed operation (756) along with the operation. The server may then compare recent confirmed operation (756) with recent confirmed operation (752) to verify that client 2 has applied all previous design operations to the local copy of the shared design object on client 2 and the local copy of the design model is therefore synchronized with the shared design model on the server.

In some examples method 300 for collaborative editing of an electronic model of a design object may include (1) receiving from the client submitting the design operation a sequence identifier that does not match the sequence identifier associated with the design operation most recently performed on the shared design model, (2) determining, in response to receiving the sequence identifier that does not match the sequence identifier associated with the most recently performed design operation, that at least one design operation performed on the shared design model has not been applied to the copy of the shared design model local to the client, and (3) notifying the client submitting the design operation that because at least one design operation performed on the shared design model has not been applied to the copy of the shared design model local to the client, the design operation was not performed on the shared design model.

Returning to FIG. 7, if client 2 (606) has not yet received operation A (610) and applied the operation to its local copy of the shared design model when submitting operation B (620), the server may determine that recent confirmed operation (756) on client 2 does not match recent confirmed operation (752) on the server. Because the local copy of the shared design model on client 2 has not been synchronized with the shared design model on the server, the server may notify client 2 that operation B may not be performed on the shared design model until the local copy of the shared design model on client 2 has been brought up to date by applying operation A.

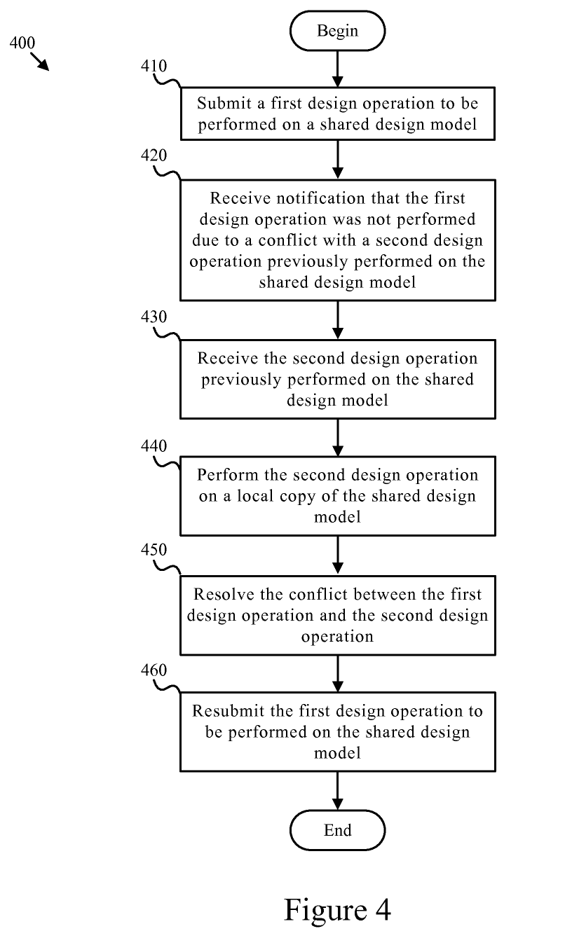

FIG. 4 is a flowchart depicting one embodiment of a method 400 for resolving conflicts arising during collaborative editing of a shared electronic model of a design object. The steps shown in FIG. 4 may be performed by any suitable computer-executable code and/or computing system. In some embodiments, the steps shown in FIG. 4 may be performed by one or more of the components of system 200 in FIG. 2, as well as systems depicted in FIGS. 6-9.

As illustrated in FIG. 4, at step 410 of method 400, one or more of the systems described herein may submit a first design operation to be performed on a shared design model. For example, operation module 204(A) may, as part of client 202(A) in FIG. 2, submit a first design operation to be performed on a shared design model. At step 420 of method 400, one or more of the systems described herein may receive notification that the first design operation was not performed due to a conflict with a second design operation previously performed on the shared design model. For example, operation module 204(A) may, as part of client 202(A) in FIG. 2, receive notification from server 210 that the first design operation was not performed due to a conflict with a second design operation that was previously submitted by client 202(B) and performed on the shared design model.

At step 430 of method 400, one or more of the systems described herein may receive the second design operation previously performed on the shared design model. For example, operation module 204(A) may, as part of client 202(A) in FIG. 2, receive from server 210 the second design operation that was previously submitted by client 202 (B) and performed on the shared design model. At step 440 of method 400, one or more of the systems described herein may perform the second design operation on a local copy of the shared design model. For example, operation module 204(A) may, as part of client 202(A) in FIG. 2, perform the second design operation on a local copy of the shared design model on client 202(A).

At step 450 of method 400, one or more of the systems described herein may resolve the conflict between the first design operation and the second design operation. For example, operation module 204(A) may, as part of client 202(A) in FIG. 2, resolve the conflict between the first design operation performed by client 202(A) and the second design operation that was performed by client 202(B) and performed on the shared design model 214 on server 210. Some conflicts may be resolved by modifying parameters of the rejected operation. Other operations may have to be reversed before applying the second operation to bring the local copy of the design model up to date before revising the first design model, applying it to the local model copy and submitting the operation to the server. The method for reversing and resubmitting an operation will be described in greater detail below in the description of method 500.

At step 460 of method 400, one or more of the systems described herein may resubmit the first design operation to be performed on the shared design model. For example, operation module 204(A) may, as part of client 202(A) in FIG. 2, resubmit the first design operation to server 210 to be applied to shared design model 214.

In some examples method 400 for resolving conflicts arising during collaborative editing of a shared electronic model of a design object may include receiving a sequence identifier associated with the second design operation previously performed on the shared design model. As previously discussed, clients may receive a sequence identifier associated with the design operation most recently performed on the server, along with the design operation to apply to the local copy of the design model. For example, in system 700 depicted in FIG. 7, when client 2 (606) receives confirmed operation A (640) from the server (602), indicating that the server has applied operation A (610) to the shared design model, the server may also transmit recent confirmed operation (752) identifying operation A as the operation most recently performed on the shared design model.

In some examples, submitting the first design operation to be performed on the shared design model may include submitting the sequence identifier associated with the second design operation previously performed on the shared design model. By submitting the sequence identifier associated with the design operation most recently received from the server, the client may indicate to the server that the local copy of the shared design model is up to date. For example, in system 700 illustrated in FIG. 7, when client 2 (606) submits operation B (620) to the server (602), client 2 may also transmit recent confirmed operation (756) to the server, indicating that client 2 has applied the most recently performed operation on the copy of the shared model local to client 2, and the local copy is therefore consistent with the shared design model on the server.

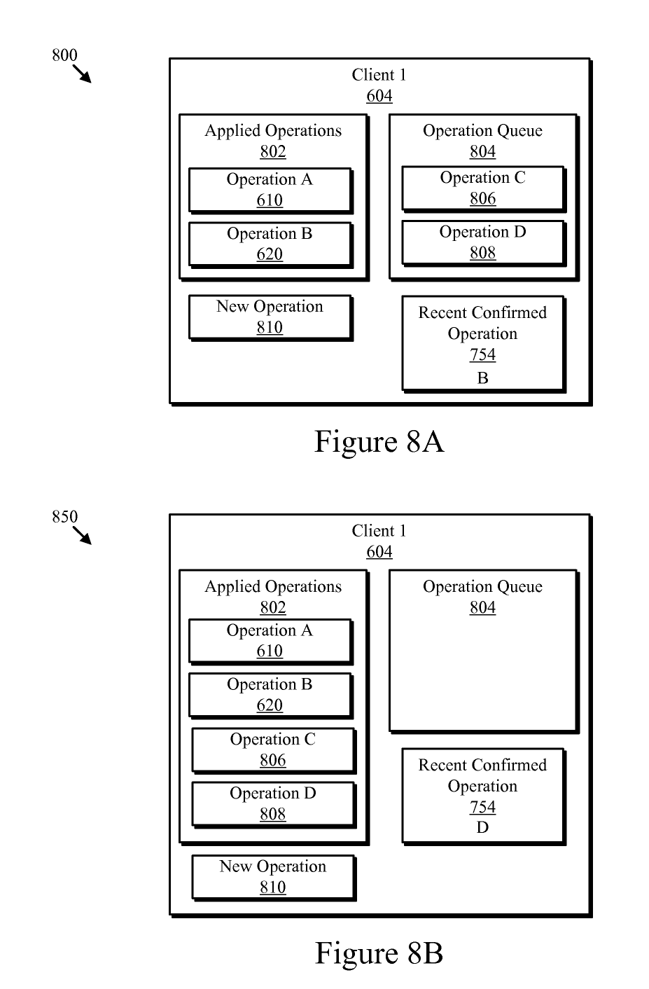

In some examples method 400 for resolving conflicts arising during collaborative editing of a shared electronic model of a design object may further include (1) receiving notification that the first design operation was not performed because the sequence identifier submitted with the first design operation does not match the sequence identifier associated with a most-recent design operation most recently performed on the shared design model, (2) receiving one or more previously performed design operation performed on the shared design model prior to when the first design operation was submitted, (3) performing the at least one previously performed design operation on a the client's local copy of the shared design model, and (4) resubmitting the first design operation with the sequence identifier of the previously performed design operation most recently received. FIG. 8A illustrates a system 800 for collaborative editing of a shared electronic model of a design object. The system 800 may include client 1 (604) with applied operations (802) that have been applied to both the local copy of the shared design model and the shared design model on the server. Recent confirmed operation (754) indicates that the server has confirmed that both operation A (610) and operation B (620) have been applied to the shared design model on the server. While the user of client 1 is preparing a new operation (810) to be submitted to the server, client 1 may receive notification that one or more operations, such as operation C (806) and operation D (808), have been applied to the shared design model on the server.

In some examples method 400 for resolving conflicts arising during collaborative editing of a shared electronic model of a design object may further include queueing the at least one previously performed design operation performed on the shared design model in a design operation queue accessible to the client, and retrieving the at least one previously performed design operation from the design operation queue to be performed on the copy of the shared design model local to the client. FIGS. 8A and 8B illustrate systems 800 and 850 for queueing design operations received while editing a design operation. Systems 800 and 850 include an operation queue 804 in which operations received from the server during an editing session may be stored until they are applied to the local copy of the shared design model. As shown in FIG. 8B, operation C (806) and operation D (808) may be applied to the local copy of the shared design model and recent confirmed operation (754) updated with the sequence identifier of the most recently applied operation. Since operation C and operation D have already been applied to the shared design model on the server, the operations should be applied to the local copy of the shared design model on client 1 (604) before applying new operation (810), so that client 1 may verify that new operation (810) does not create a conflict with previously applied design operations before submitting new operation (810) to the server.

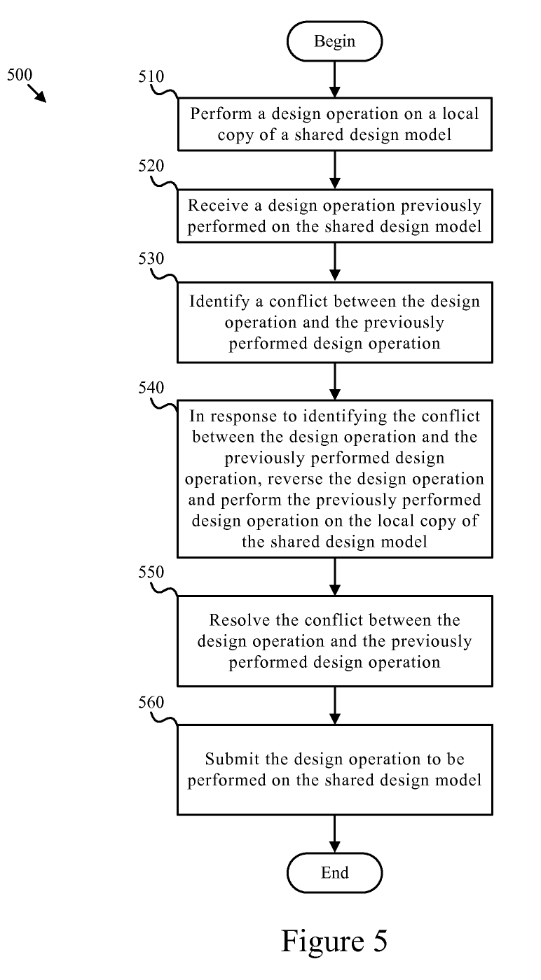

FIG. 5 is a flowchart depicting one embodiment of a method 500 for data preservation when resolving conflicts arising during collaborative editing of a shared electronic model of a design object. The steps shown in FIG. 5 may be performed by any suitable computer-executable code and/or computing system. In some embodiments, the steps shown in FIG. 5 may be performed by one or more of the components of system 200 in FIG. 2, as well as systems depicted in FIGS. 6-9.

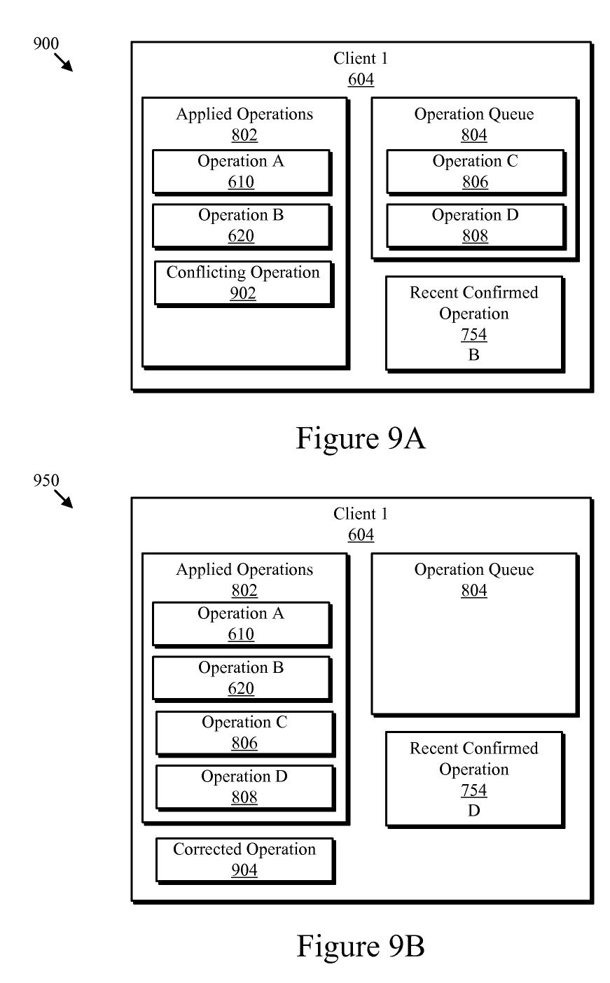

As illustrated in FIG. 5, at step 510 of method 500, one or more of the systems described herein may perform a design operation on a local copy of a shared design model. For example, operation module 204(A) may, as part of client 202(A) in FIG. 2, perform a design operation on local model copy 206(A) of shared design model 214 on server 210. At step 520 of method 500, one or more of the systems described herein may receive a design operation previously performed on the shared design model. For example, operation module 204(A) may, as part of client 202(A) in FIG. 2, receive a design operation previously submitted by client 202(B) to server 210 and performed on shared design model 214. FIGS. 9A and 9B are block diagrams depicting systems 900 and 950 for collaborative editing of a shared electronic model of a design object. FIG. 9A includes client 1 (604) with applied operations (802) that include operation A (610), operation B (620), and conflicting operation (902). Two operations, operation C (806) and operation D (808) have been received from the server and saved in operation queue (804), but not yet applied to the local copy of the shared design model.

At step 530 of method 500, one or more of the systems described herein may identify a conflict between the design operation and the previously performed design operation. For example, operation module 204(A) may, as part of client 202(A) in FIG. 2, identify a conflict between the design operation performed on local model copy 206(A) on client 202(A) and the design operation previously performed on shared design model 214 on server 210. As discussed previously, conflicts between design operations may sometimes be resolved without reversing a previously applied design operation. Returning to FIG. 9A, operation C (806) and operation D (808) have not yet been applied to the local copy of the shared design model because one of the operations has been found to conflict with conflicting operation (902).

At step 540 of method 500, one or more of the systems described herein may, in response to identifying the conflict between the design operation and the previously performed design operation, reverse the design operation and perform the previously performed design operation on the local copy of the shared design model. For example, operation module 204(A) may, as part of client 202(A) in FIG. 2, in response to identifying the conflict between the design operation and the design operation previously performed on shared design model 214 on server 210, reverse the design operation and perform the previously performed design operation on local model copy 206(A) on client 202(A). Returning to FIGS. 9A and 9B, conflicting operation (902) is reversed from the local copy of the shared design model and removed from applied operations (802). Operation C (806) and operation D (808) may then be applied to the local copy of the shared design model and recent confirmed operation (754) updated to show that operation D (808) is the most recently confirmed operation received from the server.

At step 550 of method 500, one or more of the systems described herein may resolve the conflict between the design operation and the previously performed design operation. For example, operation module 204(A) may, as part of client 202(A) in FIG. 2, resolve the conflict between the design operation and the previously performed design operation. Returning to FIGS. 9A and 9B, conflicting operation (902) may, after being reversed from the local copy of the shared design model, be corrected to obtain corrected operation (904).

At step 560 of method 500, one or more of the systems described herein may submit the design operation to be performed on the shared design model. For example, operation module 204(A) may, as part of client 202(A) in FIG. 2, submit the design operation to be performed on the shared design model. As depicted in FIG. 9B, corrected operation (904) may be applied to the local copy of the shared design model and submitted to the server to be applied to the shared design model on the server.

In one embodiment, method 500 for data preservation when resolving conflicts arising during collaborative editing of a shared electronic model of a design object may further include (1) receiving at least one additional previously performed design operation performed on the shared design model, (2) performing the at least one additional previously performed design operation on the copy of the shared design model local to the client, and (3) determining that performing the at least one previously performed design operation has resolved the conflict between the design operation and the at least one previously performed design operation. In some cases, applying a design operation may resolve a previously identified conflict between two operations. For example, in FIGS. 9A and 9B, client 1 (604) may identify a conflict between operation C (806) and conflicting operation (902). After receiving operation D (808), client 1 (604) may determine that operation D (808) resolves the conflict, so that operation C (806), operation D (808) and conflicting operation (902) may be applied to the design model with no resulting conflict.

As described above, the systems and methods described herein may facilitate collaborative CAx projects involving many designers. By applying a global order of operations, systems and methods described herein may ensure model consistency between server and client databases and facilitate resolution of conflicts between design operations with a reduced loss of work. In this way, the potential productivity of multiple designers may be more effectively leveraged to reduce the time required to complete design projects.

In summary, the methods, apparatuses, and systems presented herein provide a number of distinct advantages over prior art methods, apparatuses, and systems. It should be noted that many of the functional units described herein are identified as modules. Others are assumed to be modules. Others are assumed to be modules. One of skill in the art will appreciate that the various modules described herein may include a variety of hardware components that provide the described functionality including one or more processors such as CPUs or microcontrollers, or programmable logic devices (i.e., hardware components) that are configured by one or more software components. The software components may include executable instructions or codes and corresponding data that are stored in a computer-readable storage medium such as a non-volatile memory, or the like. The instructions or codes may include machine codes that are configured to be executed directly by the processor. Alternatively, the instructions or codes may be configured to be executed by an interpreter, or the like, that translates the instructions or codes to machine codes that are executed by the processor.

It should also be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for collaborative editing of an electronic model of a design object, executed by at least one processor, the method comprising:
identifying a plurality of clients configured to submit design operations to be performed on a shared design model;
receiving, from a first client of the plurality of clients, a first design operation to be performed on the shared design model prior to receiving, from a second client of the plurality of clients, a second design operation to be performed on the shared design model;
performing the first design operation prior to attempting to perform the second design operation;
identifying a conflict between the second design operation and the first design operation;
in response to identifying the conflict between the second design operation and the first design operation, notifying the second client that the second design operation was not performed on the shared design model.

2. The method of claim 1, further comprising notifying each client of the plurality of clients that the first design operation was performed on the shared design model.

3. The method of claim 2, wherein notifying each client of the plurality of clients that the first design operation was performed on the shared design model comprises:
notifying the first client that the first design operation was successfully performed on the shared design model;
transmitting the first design operation to other clients of the plurality of clients aside from the first client so that the first design operation can be applied to a copy of at least a portion of the shared design model local to the other clients.

4. The method of claim 1, further comprising:
associating a sequence identifier with each design operation performed on the shared design model;
notifying each client of the plurality of clients of the sequence identifier associated with each design operation performed on the shared design model.

5. The method of claim 4, wherein receiving the design operation to be performed on the shared design model further comprises receiving from the client submitting the design operation the sequence identifier most recently received by the client.

6. The method of claim 5, further comprising:
receiving from the client submitting the design operation a sequence identifier that does not match the sequence identifier associated with the design operation most recently performed on the shared design model;
determining, in response to receiving the sequence identifier that does not match the sequence identifier associated with the most recently performed design operation, that at least one design operation performed on the shared design model has not been applied to the copy of the shared design model local to the client;
notifying the client submitting the design operation that because at least one design operation performed on the shared design model has not been applied to the copy of the shared design model local to the client, the design operation was not performed on the shared design model.

7. A method for collaborative editing of an electronic model of a design object, executed by at least one processor, the method comprising:
submitting, from a client, a first design operation to be performed on a shared design model;
receiving notification that the first design operation was not performed due to a conflict with a second design operation previously performed on the shared design model.

8. The method of claim 7, further comprising:
receiving the second design operation previously performed on the shared design model;
performing the second design operation on a copy of the shared design model local to the client.

9. The method of claim 8, further comprising:
resolving, on the client, the conflict between the first design operation and the second design operation;
resubmitting, from the client, the first design operation to be performed on the shared design model.

10. The method of claim 7, further comprising receiving a sequence identifier associated with the second design operation previously performed on the shared design model.

11. The method of claim 10, wherein submitting the first design operation to be performed on the shared design model further comprises submitting the sequence identifier associated with the second design operation previously performed on the shared design model.

12. The method of claim 11, further comprising:
receiving notification that the first design operation was not performed because the sequence identifier submitted with the first design operation does not match the sequence identifier associated with a most-recent design operation most recently performed on the shared design model;
receiving at least one previously performed design operation performed on the shared design model prior to when the first design operation was submitted;
performing the at least one previously performed design operation on a copy of at least a portion of the shared design model local to the client;
resubmitting the first design operation with the sequence identifier of the previously performed design operation most recently received.

13. The method of claim 12, further comprising:
queueing the at least one previously performed design operation performed on the shared design model in a design operation queue accessible to the client;
retrieving the at least one previously performed design operation from the design operation queue to be performed on the copy of the shared design model local to the client.

14. A method for collaborative editing of an electronic model of a design object, executed by at least one processor, the method comprising:
performing, on a client, a design operation on a copy of a shared design model local to the client;
receiving, on the client, at least one previously performed design operation performed on the shared design model;
identifying a conflict between the design operation and the at least one previously performed design operation;
in response to identifying the conflict between the design operation and the at least one previously performed design operation:
reversing the design operation;
performing the at least one previously performed design operation on the copy of the shared design model local to the client;
resolving the conflict between the design operation and the at least one previously performed design operation;
submitting the design operation to be performed on the shared design model.

15. The method of claim 14, wherein resolving the conflict between the design operation and the at least one previously performed design operation comprises:
receiving at least one additional previously performed design operation performed on the shared design model;
performing the at least one additional previously performed design operation on the copy of the shared design model local to the client;
determining that performing the at least one previously performed design operation has resolved the conflict between the design operation and the at least one previously performed design operation.
